(19) United States
(12) Patent Application Publication
(10) Pub. No.: US 2025/0103329 A1
(43) Pub. Date: Mar. 27, 2025

(54) SCALABLE DETERMINISTIC SOLUTION FOR NON-DETERMINISTIC OPERATIONS

(71) Applicant: Intel Corporation, Santa Clara, CA (US)

(72) Inventors: Sarang Akotkar, Bangalore (IN); Guneshwor Singh, Bangalore (IN)

(21) Appl. No.: 18/971,183

(22) Filed: Dec. 6, 2024

(51) Int. Cl. G06F 9/30

(52) U.S. Cl. CPC G06F 9/30014

(57) ABSTRACT

Systems, apparatuses and methods may provide for technology that conducts a first split of a first floating point (FP) number into a first part and a second part, conducts a second split of a second FP number into a third part and a fourth part, conducts a first reduction sum operation between the first part and the third part to obtain a first intermediate result, and conducts a second reduction sum operation between the second part and the fourth part to obtain a second intermediate result.

### BACKGROUND

Many artificial intelligence (AI) applications use deep neural networks (DNNs), which include a high number of hidden layers to perform operations such as normalization (e.g., creating a set of features that are on the same scale as one another) and “softmax” functions (e.g., converting a vector of real numbers into a probability distribution of possible outcomes). When these operations add two floating point (FP) numbers in the digital domain (e.g., each represented by N bits), normalization of the result typically involves a reduction sum operation that discards the least significant bit (LSB) of the result and causes a loss of precision (e.g., “catastrophic cancellation” and/or a non-deterministic output). While using a higher FP representation (e.g., double FP) with respect to the reduction sum operation may provide sufficient headroom for avoiding the precision loss, such an approach may not be supported on AI hardware accelerators.

### BRIEF DESCRIPTION OF THE DRAWINGS

The various advantages of the embodiments will become apparent to one skilled in the art by reading the following specification and appended claims, and by referencing the following drawings, in which:

FIG. 1 is an illustration of an example of a floating point (FP) number represented in a single precision format according to an embodiment;

FIG. 2A is an illustration of an example of split and reduction sum operations with respect to FP numbers according to an embodiment;

FIG. 2B is an illustration of an example of split and reduction sum operations with respect to intermediate results according to an embodiment;

FIGS. 3A and 3B are illustrations of an example of split, square sum reduction and reduction sum operations with respect to FP numbers and intermediate results according to an embodiment;

FIG. 4A is a flowchart of an example of a method of conducting split and reduction sum operations with respect to FP numbers according to an embodiment;

FIG. 4B is a flowchart of an example of a method of conducting split and reduction sum operations with respect to intermediate results according to an embodiment;

FIG. 4C is a flowchart of an example of a method of conducting split, square sum reduction and reduction sum operations with respect to FP numbers and intermediate results according to an embodiment;

FIG. 5 is a block diagram of an example of a performance-enhanced computing system according to an embodiment;

FIG. 6 is an illustration of an example of a semiconductor package apparatus according to an embodiment;

FIG. 7 is a block diagram of an example of a processor according to an embodiment; and

FIG. 8 is a block diagram of an example of a multi-processor based computing system according to an embodiment.

### DETAILED DESCRIPTION

As already noted, a frequently performed operation in normalization and softmax layers of deep neural networks (DNNs) is the reduction sum operation. Given the numerical non-commutative nature of floating point (FP) additions (e.g., different ordering of calculations can produce different results), the results often vary considerably, particularly when the dimensions involved are relatively large and the additions are performed in multi-threaded architectures running on a central processing unit (CPU, e.g., host processor) and/or graphics processing unit (GPU).

In multi-threaded applications (e.g., GPU implementations executing 4K-8K threads), code can use atomic add functions to improve the efficiency and/or performance of reduction sum operations. Even though the atomic add approach may be relatively efficient, non-deterministic results may vary the training efficiency and convergence, which in turn complicates debugging. As a workaround, programmers may resort to inefficient techniques to derive deterministic results.

Additionally, previous solutions may use a higher FP representation with respect to the reduction sum operation to ensure that there is sufficient headroom to avoid precision loss (e.g., using double FP representation to carry out the reduction sum operation on single precision floating-point data). Only a few higher FP representations are supported, however, on any given hardware and artificial intelligence (AI) specific hardware is typically limited to a maximum (max) of single precision FP representation (e.g., double FP is not supported by most AI hardware accelerators). Moreover, reduction sum operations on data represented as double FP uses a “long double” format to hold the result as a deterministic output. Thus, reduction sum operations for any FP representation are prone to catastrophic cancellation and result in non-deterministic outputs.

The technology described herein provides a scalable and deterministic solution for both single- and multi-threaded applications handling reduction sum operations. The necessary arithmetic is provided herein to derive a deterministic result from otherwise non-deterministic reduction sum operations. Additionally, embodiments blend well with efficient techniques such as atomic add operations to realize reduction sum operations in multi-threaded architectures (e.g., GPUs).

The technology described herein splits each FP number into two parts such that a first part holds a significant value of the number and a second part holds the tailing bits that are often lost during arithmetic operations such as addition (add) and/or multiplication (mul) during normalization/quantization per arithmetic operation. Splitting the floating number creates a headroom of split number of bits for both the parts, rendering the reduction operation deterministic within that headroom. The involved computation of reduction sum occurs on two parts with a headroom of a split number of bits eliminating the root cause of non-deterministic results (e.g., catastrophic cancellation).

### Reduction Sum—Overview

The technology described herein splits a floating point number (including a sign bit, exponent bits and mantissa/fraction bits) in the middle of the mantissa bits. The split results in two parts—a first part holds the significant value of the original number, and a second part holds the lower precision bits that are often lost as normalization, quantization and/or truncation operations inherent in floating point arithmetic. This split in the middle of the mantissa creates the necessary headroom to avoid precision loss encountered per arithmetic operation (e.g., add/mul). Within this headroom, all the arithmetic operations involved in the reduction sum operation become deterministic as the root cause of precision loss is eliminated.

One advantage of the technology described herein is scalability (e.g., embodiments apply to all floating point representations). On hardware supporting a max single precision floating point format, double floating-point representation accuracy can be achieved through the technology described herein. The root cause of precision loss (e.g., catastrophic cancellation) is eliminated by making the reduction operation deterministic within the headroom window. Embodiments also blend well with optimization techniques used to conduct reduction sum operations (e.g., atomic add). Results are closer to higher floating point representations with respect to the input data representation.

### Reduction Sum—Basic Principle

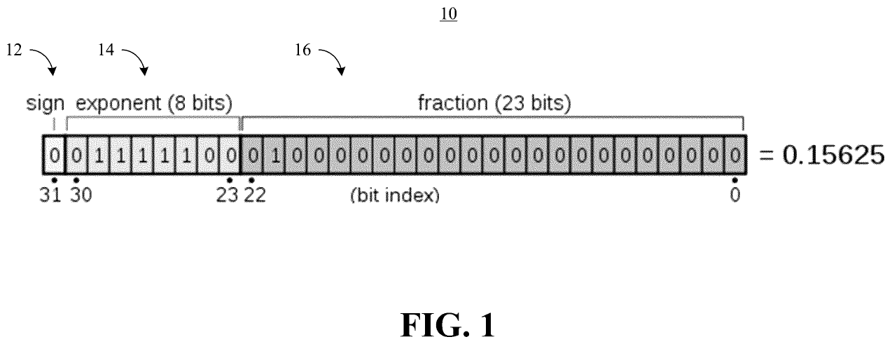

Turning now to FIG. 1, in a single precision floating point representation (e.g., 32-bit floating point/FP32 representation), an FP number 10 can include a sign bit 12, exponent bits 14 and mantissa bits 16 (e.g., fraction). The FP number 10 is first normalized to ‘1.x’, where x=mantissa/fractional part is represented in twenty-three bits and stored as a significand in trailing bits of the FP32 format and “1.0” is dropped (e.g., not explicitly stored). A bias value of 127 is added to the normalized exponent part and stored as eight signed bits.

The technology described herein splits the FP number 10 from the center of the mantissa bits 16 (e.g., at the 12^{th} bit from the least significant bit/LSB, as the “1.x” normalized form takes twenty-four bits). Splitting the FP number 10 at the center of mantissa bits 16 therefore creates a headroom of twelve bits and the reduction sum operation can occur without a loss of precision (or no loss of commutative property) for 2¹²=4096 operations on both parts. Splitting at the center of the mantissa bits 16 ensures that even during mul operations the bits are not lost, as any mul operation on a number represented with N bits generates 2N bits as result. Although the illustrated FP number 10 is in an FP32 representation to facilitate discussion, the technology described herein can be applied to any FP representation.

A reduction sum operation for data sizes greater than 4096 can be achieved by splitting the input data size into chunks of 4096. The sum operation within a given chunk of 4096 is commutative and devoid of catastrophic cancellation. The final stage reduction for a number of chunks times can again be ensured to be commutative by further splitting each chunk result as already mentioned to avoid a loss of precision. The final reduction result is held in four float variables, which code can simply add to arrive at single float value (with minimal loss of precision).

### Reduction Sum—Core Operations

(1) Split the tensor into chunks of 4096 or lesser if the data size is greater than 4096.

(2) Each thread performs a reduction sum operation on one chunk each.

(3) Split each FP input number within the chunk into two parts as already discussed to create headroom for lossless operation.

(4) Carry out a reduction sum operation on the associated chunk per thread to generate intermediate/partial results.

(5) The second (stage) reduction sum operation to derive the final lossless result is conducted by following operations (3) and (4) above on the result of each chunk.

(6) Four result variables are generated after the second reduction sum operation on the partial results. The single float variable result can be derived by performing an addition operation on these four float result variables with minimal loss of precision or the result can be held in these four result variables for further processing.

### Reduction Sum—Solution Space

As already noted, the solution space involves realizing a deterministic reduction sum operation by avoiding the normalization/quantization error associated with the addition operation caused due to catastrophic cancellation. The deterministic result is achieved by splitting the FP number 10 into two parts: a first part holding the significant part of the original FP number 10 while a second part holds the trailing bits that are often lost during addition operations due to normalization/quantization error. Splitting the FP number 10 creates headroom to derive a deterministic or lossless result. The additional overhead of splitting and one extra add operation per floating-point data can be hidden behind memory fetches given that the reduction sum operation is memory bound.

### Reduction Sum—Solution Framework

When two numbers, each represented by N bits are added, the result includes a max of ‘N+1’ bits for correct representation. For example, the IEEE (Institute for Electrical and Electronics Engineers) representation for the FP number 10 normalizes the result back to ‘1.x’ form; where x is the mantissa/significand, resulting in a loss of one bit of precision per addition (e.g., for single precision floating point representation of a real number, the mantissa is represented as: ‘1.x=1.23’). In other words, x is represented in twenty-three bits and with the ‘1.x’ form, and the FP number 10 takes 24 bits. When two such FP numbers are added, the result is twenty-five bits. The IEEE normalization operation brings the FP number 10 back to the 1.23 form, discarding the one LSB bit of the mantissa bits 16, resulting in precision loss per addition.

The technology described herein splits the mantissa bits 16 of the FP representation into two parts to create headroom to avoid precision loss per addition (e.g., when the IEEE single precision floating point representation with mantissa is represented as—‘1.x=1.23’ bits, the split is conducted as follows):
The first part is derived by setting the LSB twelve bits of the mantissa bits 16 of the original FP number 10 to zero. This part holds the significant part of the original number.
The second part equals the original FP number 10 minus the first part and holds the trailing bits susceptible to quantization error.

For the two parts, the reduction sum operation is performed independently. The headroom of twelve bits for each part allows 2¹²=4096 additions to be performed without loss of precision generating two parts of the result—the first part holding the significant part and the second part holding the trailing precision part, is mostly affected by quantization loss. As already noted, conducting the split in the center of the mantissa bits 16 accommodates operations such as mul, which generates twice the number of bits as a result. Accordingly, a mul operation on the parts will not lose any precision bits after the operation.

For a reduction sum operation on single precision floating point data of size one million, the operations involved are as follows:

(1) Split the input data into std::ceil(1000000/4096)=245 chunks, each of size=4082.

(2) Split each FP number 10 into two single precision floating point parts as already discussed.

(3) Carry out a reduction sum operation on each chunk, where the last chunk will have ninety fewer samples.

(4) The above operations will result in 245*2 intermediate results of single precision floating or FP32 numbers.

(5) Split each 245*2 single precision FP result again into two single precision floats as already discussed and carry out the reduction operation for 245*2*2 times.

(6) The final reduction result is available as four single precision FP numbers, which is more accurate giving a deterministic result comparable/closer to a higher data representation type such as double/long double.

The technology described herein therefore provides deterministic reduction operation without using higher FP representations (e.g., double or long double precision) for reduction sum operations on single precision FP data, achieving the same level of accuracy as of double or long double precision. The technology described herein also does not require complex arithmetic operations that are used for double, division or multiplication operations. Moreover, the technology described herein blends well with performance efficient techniques used to optimize reduction sum operations (e.g., atomic adds).

Embodiments therefore provide an enhanced scheme to carry out deterministic reduction sum operations without using higher floating point representations. Embodiments blend well with performance efficient reduction sum realization techniques such as atomic add, which is supported by most underlying hardware.

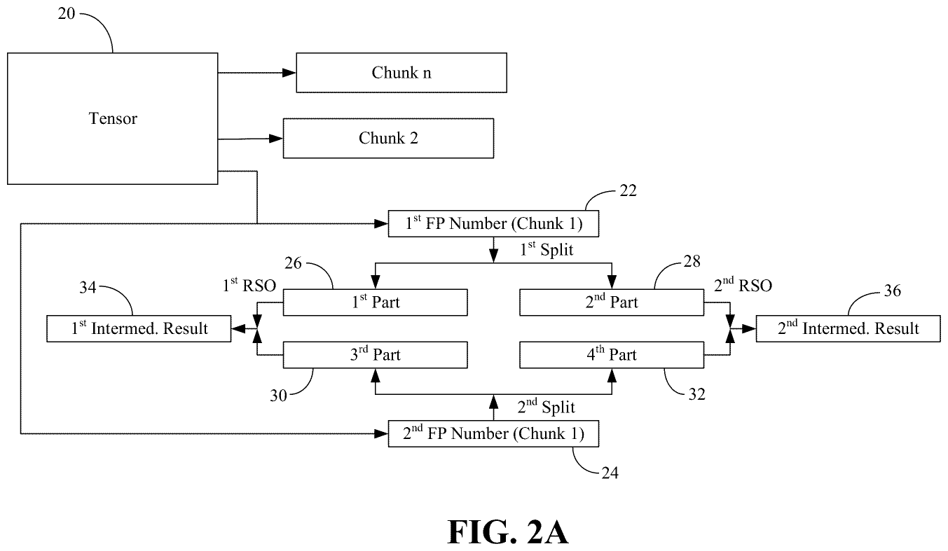

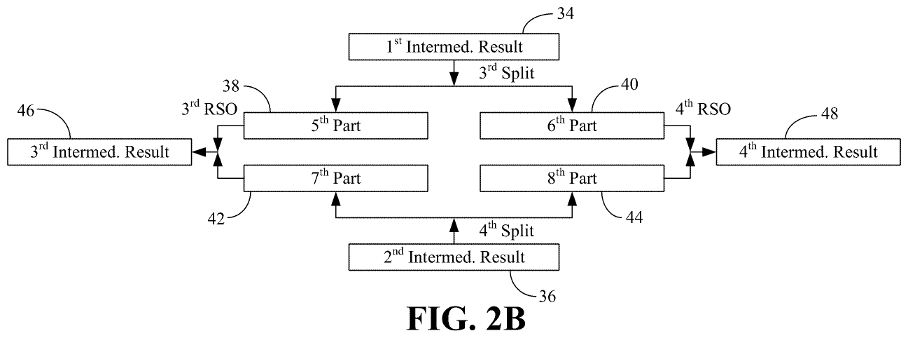

FIG. 2A shows a solution in which a tensor 20 is split into a plurality of chunks (“Chunk 1” to “Chunk n”), wherein a first chunk includes a 1^{st} FP number 22 and a 2^{nd} FP number 24. The 1^{st} FP number 22 and the 2^{nd} FP number 24 may be in a single precision format. In the illustrated example, a 1^{st} split of the 1^{st} FP number 22 into a 1^{st} part 26 and a 2^{nd} part 28 is conducted. Similarly, a 2^{nd} split of the 2^{nd} FP number 24 into a 3^{rd} part 30 and a 4^{th} part 32 is conducted. In an embodiment, the 1^{st} split is conducted at a center of mantissa bits in the 1^{st} FP number 22 and the 2^{nd} split is conducted at a center of mantissa bits in the 2^{nd} FP number 24. A 1^{st} reduction sum operation (RSO) is conducted between the 1^{st} part 26 and the 3^{rd} part 30 to obtain a 1^{st} intermediate result 34. Similarly, a 2^{nd} RSO is conducted between the 2^{nd} part 28 and the 4^{th} part 32 to obtain a 2^{nd} intermediate result 36. Thus, the 1^{st} split and the 2^{nd} split create headroom to render the 1^{st} intermediate result 34 and the 2^{nd} intermediate result 36, respectively, deterministic. In an embodiment, the 1^{st} RSO and the 2^{nd} RSO are conducted within a normalization layer (e.g., batch-norm, layer-norm, instance-norm, group-norm, etc.) of an AI model.

FIG. 2B shows a solution in which a 3^{rd} split of the 1^{st} intermediate result 34 into a 5^{th} part 38 and a 6^{th} part 40 is conducted. Similarly, a 4^{th} split of the 2^{nd} intermediate result into a 7^{th} part 42 and an 8^{th} part 44 is conducted. Again, the 3^{rd} split and the 4^{th} split may be conducted at a center of mantissa bits in the 1^{st} intermediate result 34 and the 2^{nd} intermediate result 36, respectively. In the illustrated example, a 3^{rd} RSO is conducted between the 5^{th} part 38 and the 7^{th} part 42 to obtain a 3^{rd} intermediate result 46. Similarly, a 4th RSO is conducted between the 6^{th} part 40 and the 8^{th} part 44 to obtain a 4^{th} intermediate result 48. In an embodiment, the 3^{rd} split and the 4^{th} split create headroom to render the 3^{rd} intermediate result 46 and the 4^{th} intermediate result 48, respectively, deterministic. The 1^{st} intermediate result 34, the 2^{nd} intermediate result 36, the 3rd intermediate result 46 and the 4^{th} intermediate result 48 can be summed together to obtain final summation results with minimal loss of precision (e.g., on the order of double FP as a baseline).

### Square Sum Reduction—Overview

During the training phase of normalization layers in deep neural networks, first order statistics (e.g., mean via reduction sum) and second order statistics (e.g., standard deviation via square sum reduction) are typically computed. Square sum reduction operations (e.g., variance, which is a precursor to standard deviation) are highly sensitive to numerical precision, particularly when the mean is much greater than the variance. If not handled properly, the variance computation leads to values that are not-a-number (“NaN's”), which causes divergence of the training. Due to loss of precision, the single pass variance computation takes negative values, and a square root of negative values leads to NaN's.

Numerically stable solutions to square sum reduction operations are often costly in terms of performance. Also, given the numerical non-commutative nature of floating-point additions (e.g., due to catastrophic cancellation), the statistics computations are numerically imprecise. Accordingly, results can vary significantly, particularly when the dimensions involved are relatively large and computed by multi-threaded applications common on CPUs and GPUs.

More particularly, conventional solutions may use a two pass (e.g., naïve) approach that computes the statistics (e.g., mean and variance) independently by reading the input twice. The two pass approach encounters two issues. First, the approach encounters catastrophic cancellation and produces non-deterministic results. Second, reading the input twice has a negative impact on performance because available bandwidth is limited.

Another approach termed the Welford's online algorithm may use an arithmetically costly division operation per sample to estimate mean and variance. The underlying hardware may not support the division operation and an approximation might be used, leading to loss of precision and delayed convergence or accuracy of the DNN model. Moreover, the statistical computation is non-deterministic and may affect the training accuracy and convergence.

Other solutions may use a shifted data procedure that takes the center data as mean and computes the statistic in a single pass. The shifted data procedure suffers from non-deterministic results as described for the naïve algorithm and can still produce NaN's due to variance becoming negative.

Some solutions may also use a larger data format to achieve sufficient headroom (e.g., using double data format to hold the reduction results). As already noted, not all higher floating-point representations are supported on a given hardware platform. For example, double precision is not supported by most AI hardware accelerators. If the reduction operation is conducted on double precision FP numbers, the result itself will become a numerically unstable and non-deterministic operation if long double representation is not supported (e.g., resulting in NaN's).

The technology described herein provides a scalable, numerically stable, and deterministic solution for both single- and multi-threaded applications. Embodiments extract deterministic results out of reduction sum operations as already discussed. For square sum reduction operations used in variance computation, an additional operation derives numerically stable results.

Again, the technology described herein splits the floating point number into two parts in which the first part holds a significant value of the number and the second part holds the tailing bits (e.g., bits often lost during arithmetic operations such as add/mul during normalization/quantization common in floating-point arithmetic). Splitting the floating number therefore creates a headroom of a split number of bits, rendering the reduction operation deterministic with the headroom. The involved reduction sum computation is conducted on two parts with a headroom of split number of bits eliminating the root cause of non-deterministic results (e.g., catastrophic cancellation). For square sum reduction operations, an additional split operation of the squared number is conducted, as squaring the parts consumes all the headroom created in the first split.

### Square Sum Reduction—Basic Principle

Returning to FIG. 1, the technology described herein splits the FP number 10 from the center of the mantissa bits 16 (e.g., at the 12^{th} bit from the LSB, as the “1.x” normalized form takes twenty-four bits). Splitting the FP number 10 at the center of mantissa bits 16 therefore creates a headroom of twelve bits and the reduction sum operation can occur without a loss of precision (or no loss of commutative property) for 2¹²=4096 operations on both parts. For square sum reduction operations, a second split is conducted because the squaring operation consumes all the headroom created by splitting the FP number 10. Square sum reduction produces twelve float variables as the square sum reduction result, which code can simply add to arrive at single float value (e.g., with minimal loss of precision).

### Square Sum Reduction—Core Operations

(1) Split the tensor into chunks of 4096 or lesser if the data size is greater than 4096.

(2) Each thread performs reduction sum and square sum operations on one chunk each.

(3) Split each input FP number 10 within the chunk into two parts as already described to create headroom for lossless operation.

(4) For reduction square sum operations, before performing reduction sum, the squared number is split again as squaring operation consumes all the headroom bits in the first split.

(5) Carry out the reduction sum operation on the associated chunk per thread per part, to generate intermediate/partial results.

(6) The second (stage) reduction operation to derive the final lossless result can be derived by following operations (3) and (4) above.

(7) Thus 4/12 variables holding the result values are generated for reduction sum and reduction square sum. The single float variable result is derived by performing the addition operation on these 4/12 float result variables with minimal loss of precision.

### Square Sum Reduction—Solution Space

The solution space involves realizing a deterministic reduction sum operation by avoiding the normalization/quantization error associated with the addition operation caused due to catastrophic cancellation. The deterministic result is achieved by splitting the FP number 10 into two parts: a first part holding the significant part of the original FP number 10 while a second part holds the trailing bits that are often lost during addition operations due to normalization/quantization error. Splitting the FP number 10 creates headroom to derive a deterministic or lossless result. For performing reduction square sum operations, a second split is conducted on the squared float number to achieve numeric stability and deterministic results as squaring operation consumes all the headroom created during first split. The additional overhead of splitting and one extra add operation per floating-point data can be hidden behind memory fetches given that the reduction sum operation is memory bound.

### Square Sum Reduction—Solution Framework

For performing reduction square sum of single precision floating point data of size one million, the operations involved are as follows:

(1) Split the input data into std::ceil(1000000/4096)=245 chunks, each of size=4082.

(2) Split each FP number 10 into two single precision floating point parts as already discussed.

(3) Squaring the two parts results in three outputs given: (a+b)\hat{ }2=a\hat{ }2+2ab+b\hat{ }2.

(4) Split the three outputs of the square operation, as the squaring operation consumes the headroom created in the first split: N*N=2N=> a N bit represented number gives result as 2N bits.

(5) Carry out a reduction sum operation on each part and chunk, where the last chunk will have ninety fewer samples.

(6) The above operations will result in 245*6 intermediate results.

(7) Split each 245*6 single precision floating-point result again into two single precision floats as already discussed and carry out the reduction operation 245*6*2 times.

(8) The final reduction result will be available as twelve single precision floating point numbers, which will be more accurate giving a numerically stable and deterministic result.

The technology described herein therefore provides numerically stable and deterministic reduction sum and square sum operation without using higher FP representations (e.g., double or long double precision), while achieving the same level of accuracy as of double or long double precision. The technology described herein also does not require complex arithmetic operations that are used for double or division or multiplication operations. Moreover, the technology described herein blends well with generic optimization techniques such as atomic operations.

Embodiments therefore provide an improved scheme of carrying out numerically stable and deterministic reduction sum and square sum operations without involving support for higher FP representations or performance costly methods. The proposed scheme blends well with the efficient techniques used for optimizing reduction performance such as atomic operation. Embodiments also give numerically stable as well as deterministic results for the statistic computation part of normalization layer.

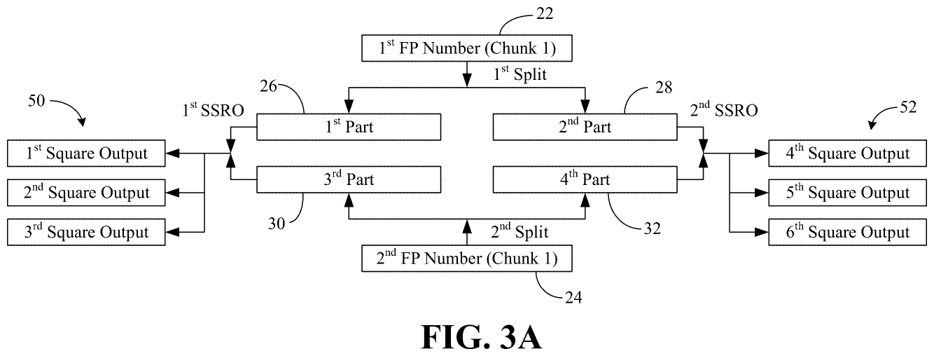

FIG. 3A shows a solution in which a 1^{st} square sum reduction operation (SSRO) is conducted between the 1^{st} part 26 and the 3^{rd} part 30 to obtain 1^{st}, 2^{nd} and 3^{rd} square outputs 50. Similarly, a 2^{nd} SSRO is conducted between the 2^{nd} part 28 and the 4^{th} part 32 to obtain 4^{th}, 5^{th} and 6^{th} square outputs 52.

With continuing reference to FIGS. 3A and 3B, a 5^{th} split of the 1st, 2^{nd} and 3^{rd} square outputs 50 into 1^{st}, 2^{nd}, 3^{rd}, 4^{th}, 5^{th}, and 6^{th} square parts 54 is conducted. Similarly, a 6^{th} split of the 4^{th}, 5^{th} and 6^{th} square outputs 52 into 7^{th}, 8^{th}, 9^{th}, 10^{th}, 11^{th} and 12^{th} square parts 56 is conducted. In the illustrated example, a 5^{th} RSO is conducted on the 1^{st}, 2^{nd}, 3^{rd}, 4^{th}, 5^{th} and 6^{th} square parts 56 to obtain 1^{st}, 2^{nd}, 3^{rd}, 4^{th}, 5^{th} and 6^{th} intermediate square results 58. Similarly, a 6^{th} RSO is conducted on the 7^{th}, 8^{th}, 9^{th}, 10^{th}, 11^{th} and 12^{th} square parts to obtain 7^{th}, 8^{th}, 9^{th}, 10^{th}, 11^{th} and 12^{th} intermediate square results 60.

### Split Instructions—Overview

As already noted, reduction sum and square sum are frequently used operations in DNNs. More prominently, reduction operations are performed in normalization, softmax layers, and so forth. Given the numerical non-commutative nature of FP additions, the results often vary significantly, particularly when the dimensions involved are relatively large and the multi-threaded implementation is running on a CPU or GPU.

Using a higher FP representation for reduction operations (e.g., using double FP representation to carry out the reduction sum operation on single precision FP data) may ensure that there is a sufficient headroom for avoiding the precision loss. Not all FP representations, however, are supported on given hardware (e.g., AI specific hardware). But this issue is representation agnostic. For example, if a reduction operation is conducted on an FP data represented as double precision and the maximum available precision is double, the result may need to be of the type ‘long double’ to derive a numerically stable and deterministic output (e.g., which is not possible). The issue of numerical instability and non-deterministic nature of reduction sum and square sum operations is therefore representation agnostic.

The technology described herein provides new instructions for CPU and GPU hardware to derive numerically stable, deterministic, and scalable solution for reduction sum and square sum operations as discussed above. More particularly, embodiments split the FP number into two parts such that the first part holds a significant value of the number and the second part holds the tailing bits (e.g., bits often lost during arithmetic operations such as add/mul during normalization/quantization per FP arithmetic operation).

Splitting the floating number therefore creates a headroom of split number of bits for both the parts, rendering the reduction operation deterministic within that headroom. The involved computation of reduction sum now occurs on two parts with a headroom of split number of bits eliminating the root cause of non-deterministic results (e.g., catastrophic cancellation).

More particularly, the technology described herein provides new instructions to split an FP number in the middle of mantissa bits into two parts, where the first part holds the significant value of the original number, and second part holds the lower precision bits that are often lost as normalization operation inherent in the FP arithmetic. This split in the middle of the mantissa creates the necessary headroom for avoiding precision loss encountered per arithmetic operation such as add and mul. Within this headroom, all the arithmetic operations involved in the reduction sum operation become deterministic as the root cause of precision loss is eliminated.

For square sum reduction operations, the split is conducted twice. The first split is followed by squaring operation on the two split parts. The second split is conducted on the squared two parts of the first split, to derive a numerically stable and deterministic output as the mul operation consumes all the headroom created in the first split. The performance overhead arising due to split operation can be reduced significantly by conducting the split in hardware as an instruction set architecture (ISA) instruction rather than in software.

The technology described herein provides new instructions to optimize the reduction operation significantly. For example, latency can be reduced by more than 40% with respect to conducting the same operation in software. Additionally, the new instructions are applicable for both CPUs and GPUs. Results are closer to using a higher FP representation with respect to the input data representation.

### Split Instructions—Basic Principle

Returning to FIG. 1, the technology described herein splits the FP number 10 from the center of the mantissa bits 16 (e.g., at the 12^{th} bit from the LSB, as the “1.x” normalized form takes twenty-four bits). Splitting the FP number 10 at the center of mantissa bits 16 therefore creates a headroom of twelve bits and the reduction sum operation can occur without a loss of precision (or no loss of commutative property) for 2¹²=4096 operations on both parts.

### Split Instructions—Core Operations

C++ code to split the single precision floating-point number is as follows:

unsigned whole = *reinterpret_cast<unsigned *>(&sample);
unsigned f1 = (whole >> 12) << 12;
float ff1 = *reinterpret_cast<float *>(&f1);
float ff2 = sample − ff1;

Pseudo code with the proposed new instruction is as follows:

```
Std::pair ff = asm (“float_split %1,%0”
    : “=r” (ff)
    : “r” (whole));
C++ code to conduct reduction sum operations is as follows:
float split_reduce_sum(std::list<float> samples, int num_acc = 1)
{
  std::vector<float> sum1(num_acc, 0);
  std::vector<float> sum2(num_acc, 0);
  int acc_id = 0;
  for (auto sample : samples)
  {
      unsigned whole = *reinterpret_cast<unsigned *>(&sample);
      unsigned f1 = (whole >> 12) << 12;
      float ff1 = *reinterpret_cast<float *>(&f1);
      float ff2 = sample − ff1;
      sum1[acc_id] += ff1;
      sum2[acc_id] += ff2;
      acc_id = (acc_id + 1) % num_acc;
  }
  ...
}
```

With the proposed new split instruction (e.g., float_split) to conduct reduction sum operations:

```
float split_reduce_sum(std::list<float> samples, int num_acc = 1)
{
  std::vector<float> sum1(num_acc, 0);
  std::vector<float> sum2(num_acc, 0);
  int acc_id = 0;
  for (auto sample : samples)
  {
    std::pair<float, float> ff;
    asm (“float_split %1,%0”
      : “=r“ (ff)
      : “r” (whole));
    sum1[acc_id] += ff.first;
    sum2[acc_id] += ff.second;
    acc_id = (acc_id + 1) % num_acc;
  }
  ...
}
```

A similar instruction can be used to conduct square reduction sum operations. For example, “float_split” might become “float_split_square” in the above example for square sum reduction operations. Indeed, the instruction set architecture can be modified to include all possible instruction combinations as described herein (e.g., float_split, float_split_sum, float_split_square, float_split_square_split, etc.).

### Split Instructions—Solution Space

The solution space includes split instructions for FP data, which is applicable for both CPU and GPU, to realize a numerically stable, deterministic, and scalable reduction operation by avoiding the effect of normalization associated with the addition operation. The deterministic result is achieved by splitting the FP number 10 into two parts: a first part holding the significant part of the original FP number 10 while a second part holds the trailing bits that are often lost during addition operations due to normalization/quantization error. Splitting the FP number 10 creates headroom to derive a deterministic or lossless result.

### Split Instructions—Solution Framework

The technology described herein uses split instructions to split the mantissa bits 16 of the FP representation into two parts to create headroom to avoid precision loss per addition (e.g., when the IEEE single precision floating point representation with mantissa is represented as—‘1.x=1.23’ bits, the split is conducted as follows):
The first part is derived by setting the LSB twelve bits of the mantissa bits 16 of the original FP number 10 to ‘0’. This part holds the significant part of the original number.
The second part equals the original FP number 10 minus the first part and holds the trailing bits susceptible to quantization error.

The split in the center of the mantissa bits accommodates operations such as mul (e.g., squaring), which consumes all the headroom bits to hold the result precisely. Mul/squaring of number(s) represented by N bits results in 2N bits as output, out of which N trailing bits are thrown out as truncation or normalization and round operations.

The technology described herein therefore provides a numerically stable, deterministic, and scalable reduction operation result without using higher FP representations (e.g., double or long double precision) for reduction sum operations on single precision FP data, while achieving the same level of accuracy as double or long double precision representations. The technology described herein also provides a new instruction set to carry out the split of floating-point numbers applicable in both CPUs and GPUs.

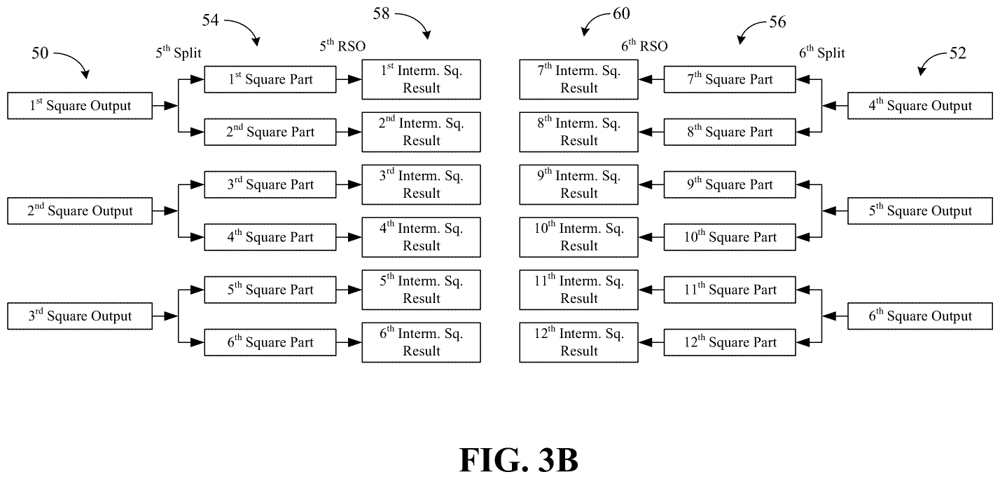

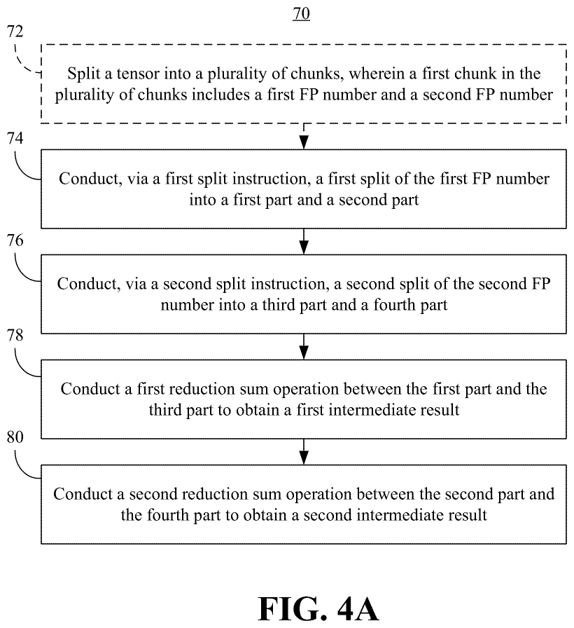

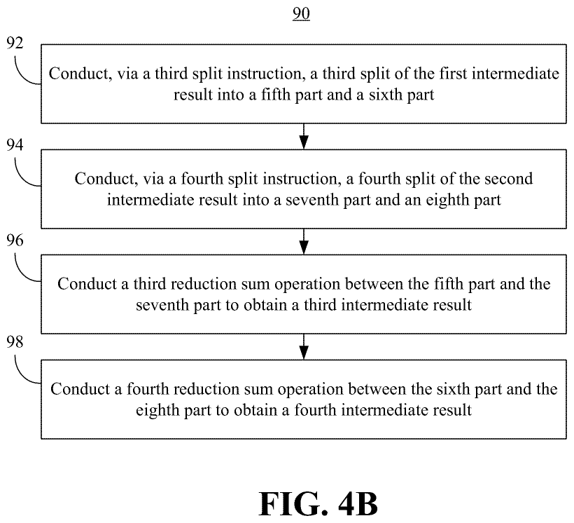

FIG. 4A shows a method 70 of conducting split and reduction sum operations with respect to FP numbers. The method 70 may be implemented in one or more modules as a set of logic instructions stored in a processor, machine- or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic (e.g., configurable hardware) include suitably configured programmable logic arrays (PLAs), field programmable gate arrays (FPGAs), complex programmable logic devices (CPLDs), and general purpose microprocessors. Examples of fixed-functionality logic (e.g., fixed-functionality hardware) include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

Computer program code to carry out operations shown in the method 70 can be written in any combination of one or more programming languages, including an object-oriented programming language such as JAVA, SMALLTALK, C++ or the like and conventional procedural programming languages, such as the “C” programming language or similar programming languages. Additionally, logic instructions might include assembler (asm) instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 72 provides for splitting (e.g., via a seventh split instruction), a tensor into a plurality of chunks, wherein a first chunk in the plurality of chunks includes a first FP number and a second FP number. In one example, block 72 may be bypassed if the data size is less than or equal to 4096. Block 74 conducts, via a first split instruction, a first split of the first FP number into a first part and a second part. Block 76 conducts, via a second split instruction, a second split of the second FP number into a third part and a fourth part. In an embodiment, the first split is conducted at a center of mantissa bits in the first FP number and the second split is conducted at a center of mantissa bits in the second FP number. Moreover, the first FP number and the second FP number may be in a single precision format.

Additionally, block 78 conducts a first reduction sum operation between the first part and the third part to obtain a first intermediate result. Similarly, block 80 conducts a second reduction sum operation between the second part and the fourth part to obtain a second intermediate result. In an embodiment, the first reduction sum operation and the second reduction sum operation are conducted within a normalization layer of an AI model. The method 70 therefore enhances performance at least to the extent that splitting the FP numbers improves accuracy (e.g., eliminates precision loss), avoids catastrophic cancellation and/or provides a deterministic output. Indeed, lower precision floating point representations can achieve the same results of higher precision floating point representations via the technology described herein. Additionally, using the single precision format improves scalability (e.g., applicability to a wider range of hardware) and using the ISA split instructions reduces latency with respect to traditional software. Moreover, the method 70 can be applied to all operators involving cumulative sum or multiplication.

FIG. 4B shows a method 90 of conducting split and reduction sum operations with respect to intermediate results. The method 90 may generally be implemented in conjunction with the method 70 (FIG. 4A), already discussed. More particularly, the method 90 may be implemented in one or more modules as a set of logic instructions stored in a processor, machine- or computer-readable storage medium such as RAM, ROM, programmable ROM (PROM), firmware, flash memory, etc., in hardware, or any combination thereof.

Illustrated processing block 92 provides for conducting, via a third split instruction, a third split of the first intermediate result into a fifth part and a sixth part. Block 94 conducts, via a fourth split instruction, a fourth split of the second intermediate result into a seventh part and an eighth part. Additionally, block 96 conducts a third reduction sum operation between the fifth part and the seventh part to obtain a third intermediate result. Similarly, block 98 conducts a fourth reduction sum operation between the sixth part and the eighth part to obtain a fourth intermediate result. As already noted, the first, second, third and fourth intermediate results can be summed together to obtain final summation results with minimal loss of precision (e.g., on the order of double FP as a baseline).

FIG. 4C shows a method 100 of conducting split, square sum reduction and reduction sum operations with respect to FP numbers and intermediate results. The method 100 may generally be implemented in conjunction with the method 70 (FIG. 4A) and/or the method 90 (FIG. 4B), already discussed. More particularly, the method 100 may be implemented in one or more modules as a set of logic instructions stored in a processor, machine- or computer-readable storage medium such as RAM, ROM, programmable ROM (PROM), firmware, flash memory, etc., in hardware, or any combination thereof.

Illustrated processing block 102 provides for conducting a first square sum reduction operation between the first part and the third part to obtain a first square output, a second square output and a third square output. Block 104 conducts a second square sum reduction sum operation between the second part and the fourth part to obtain a fourth square output, a fifth square output and a sixth square output. Additionally, block 106 may conduct, via a fifth split instruction, a fifth split of the first square output, the second square output and the third square output into a first square part, a second square part, a third square part, a fourth square part, a fifth square part and a sixth square part. Similarly, block 108 conducts, via a sixth split instruction, a sixth split of the fourth square output, the fifth square output and the sixth square output into a seventh square part, an eighth square part, a ninth square part, a tenth square part, an eleventh square part and a twelfth square part. In an embodiment, block 110 conducts a fifth reduction sum operation on the first square part, the second square part, the third square part, the fourth square part, the fifth square part and the sixth square part to obtain a first intermediate square result, a second intermediate square result, a third intermediate square result, a fourth intermediate square result, a fifth intermediate square result and a sixth intermediate square result. Similarly, block 112 conducts a sixth reduction sum operation on the seventh square part, the eighth square part, the ninth square part, the tenth square part, the eleventh square part and the twelfth square part to obtain an seventh intermediate square result, an eighth intermediate square result, a ninth intermediate square result, a tenth intermediate square result, an eleventh intermediate square result and a twelfth intermediate square result.

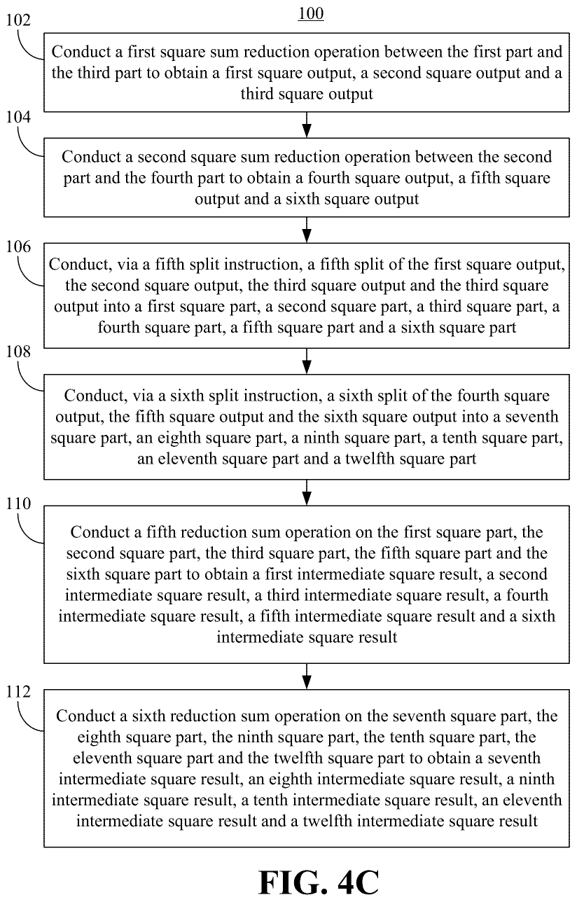

Turning now to FIG. 5, a performance-enhanced computing system 280 is shown. The system 280 may generally be part of an electronic device/platform having computing functionality (e.g., personal digital assistant/PDA, notebook computer, tablet computer, convertible tablet, edge node, server, cloud computing infrastructure), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), Internet of Things (IoT) functionality, drone functionality, etc., or any combination thereof.

In the illustrated example, the system 280 includes a host processor 282 (e.g., CPU) having an integrated memory controller (IMC) 284 that is coupled to a system memory 286 (e.g., dual inline memory module/DIMM including dynamic RAM/DRAM). In an embodiment, an IO (input/output) module 288 is coupled to the host processor 282. The illustrated IO module 288 communicates with, for example, a display 290 (e.g., touch screen, liquid crystal display/LCD, light emitting diode/LED display), mass storage 302 (e.g., hard disk drive/HDD, optical disc, solid state drive/SSD) and a network controller 292 (e.g., wired and/or wireless). The host processor 282 may be combined with the IO module 288, a graphics processor 294 (e.g. graphics processing unit/GPU), and an AI accelerator 296 (e.g., specialized processor) into a system on chip (SoC) 298.

In an embodiment, the host processor 282 includes ISA instructions 300 to perform one or more aspects of the method 70 (FIG. 4A), the method 90 (FIG. 4B) and/or the method 100 (FIG. 4C), already discussed. Thus, execution of the ISA instructions 300 causes the host processor 282 to conduct, via a first split instruction, a first split of the first FP number into a first part and a second part and conduct, via a second split instruction, a second split of the second FP number into a third part and a fourth part. Execution of the ISA instructions may also cause the host processor 282 to conduct a first reduction sum operation between the first part and the third part to obtain a first intermediate result and conduct a second reduction sum operation between the second part and the fourth part to obtain a second intermediate result.

The computing system 280 is therefore considered performance-enhanced at least to the extent that splitting the FP numbers improves accuracy (e.g., eliminates precision loss), avoids catastrophic cancellation and/or provides a deterministic output. Additionally, using a single precision format for the FP numbers improves scalability (e.g., applicability to a wider range of hardware) and using the ISA instructions 300 reduces latency with respect to traditional software. Although the ISA instructions 300 are shown in the host processor 282, the ISA instructions may reside elsewhere in the computing system 280.

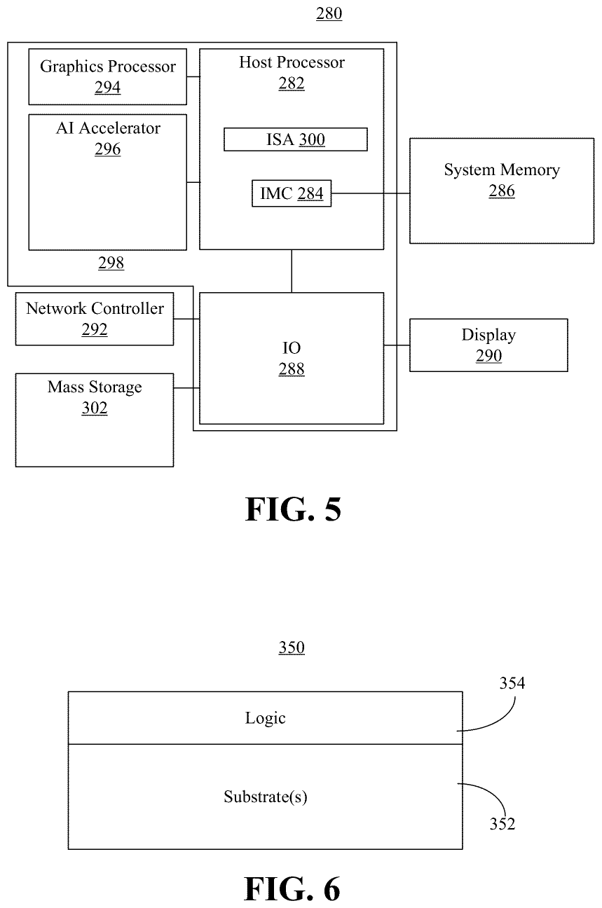

FIG. 6 shows a semiconductor apparatus 350 (e.g., chip, die, package). The illustrated apparatus 350 includes one or more substrates 352 (e.g., silicon, sapphire, gallium arsenide) and logic 354 (e.g., transistor array and other integrated circuit/IC components) coupled to the substrate(s) 352. In an embodiment, the logic 354 implements one or more aspects of the method 70 (FIG. 4A), the method 90 (FIG. 4B) and/or the method 100 (FIG. 4C), already discussed.

The logic 354 may be implemented at least partly in configurable or fixed-functionality hardware. In one example, the logic 354 includes transistor channel regions that are positioned (e.g., embedded) within the substrate(s) 352. Thus, the interface between the logic 354 and the substrate(s) 352 may not be an abrupt junction. The logic 354 may also be considered to include an epitaxial layer that is grown on an initial wafer of the substrate(s) 352.

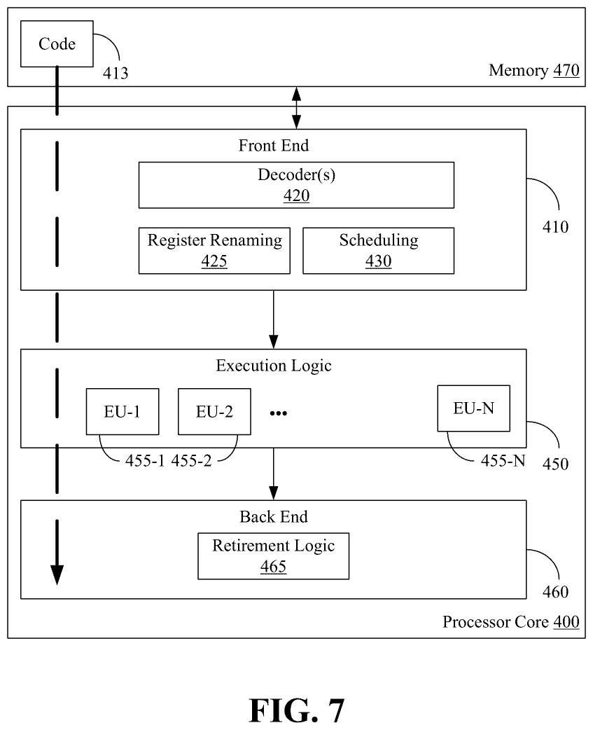

FIG. 7 illustrates a processor core 400 according to one embodiment. The processor core 400 may be the core for any type of processor, such as a micro-processor, an embedded processor, a digital signal processor (DSP), a network processor, or other device to execute code. Although only one processor core 400 is illustrated in FIG. 7, a processing element may alternatively include more than one of the processor core 400 illustrated in FIG. 7. The processor core 400 may be a single-threaded core or, for at least one embodiment, the processor core 400 may be multithreaded in that it may include more than one hardware thread context (or “logical processor”) per core.

FIG. 7 also illustrates a memory 470 coupled to the processor core 400. The memory 470 may be any of a wide variety of memories (including various layers of memory hierarchy) as are known or otherwise available to those of skill in the art. The memory 470 may include one or more code 413 instruction(s) to be executed by the processor core 400, wherein the code 413 may implement the method 70 (FIG. 4A), the method 90 (FIG. 4B) and/or the method 100 (FIG. 4C), already discussed. The processor core 400 follows a program sequence of instructions indicated by the code 413. Each instruction may enter a front end portion 410 and be processed by one or more decoders 420. The decoder 420 may generate as its output a micro operation such as a fixed width micro operation in a predefined format, or may generate other instructions, microinstructions, or control signals which reflect the original code instruction. The illustrated front end portion 410 also includes register renaming logic 425 and scheduling logic 430, which generally allocate resources and queue the operation corresponding to the convert instruction for execution.

The processor core 400 is shown including execution logic 450 having a set of execution units 455-1 through 455-N. Some embodiments may include a number of execution units dedicated to specific functions or sets of functions. Other embodiments may include only one execution unit or one execution unit that can perform a particular function. The illustrated execution logic 450 performs the operations specified by code instructions.

After completion of execution of the operations specified by the code instructions, back end logic 460 retires the instructions of the code 413. In one embodiment, the processor core 400 allows out of order execution but requires in order retirement of instructions. Retirement logic 465 may take a variety of forms as known to those of skill in the art (e.g., re-order buffers or the like). In this manner, the processor core 400 is transformed during execution of the code 413, at least in terms of the output generated by the decoder, the hardware registers and tables utilized by the register renaming logic 425, and any registers (not shown) modified by the execution logic 450.

Although not illustrated in FIG. 7, a processing element may include other elements on chip with the processor core 400. For example, a processing element may include memory control logic along with the processor core 400. The processing element may include I/O control logic and/or may include I/O control logic integrated with memory control logic. The processing element may also include one or more caches.

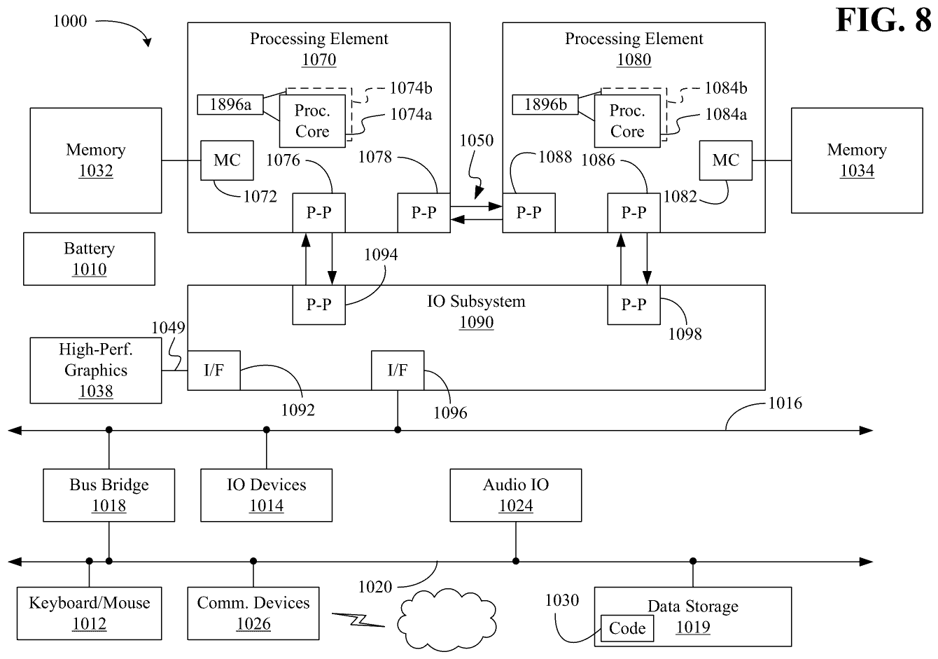

Referring now to FIG. 8, shown is a block diagram of a computing system 1000 embodiment in accordance with an embodiment. Shown in FIG. 8 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 8 may be implemented as a multi-drop bus rather than point-to-point interconnect.

As shown in FIG. 8, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 7.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 8, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 8, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 8, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement the method 70 (FIG. 4A), the method 90 (FIG. 4B) and/or the method 100 (FIG. 4C), already discussed. Further, an audio I/O 1024 may be coupled to second bus 1020 and a battery 1010 may supply power to the computing system 1000.

Note that other embodiments are contemplated. For example, instead of the point-to-point architecture of FIG. 8, a system may implement a multi-drop bus or another such communication topology. Also, the elements of FIG. 8 may alternatively be partitioned using more or fewer integrated chips than shown in FIG. 8.

### Additional Notes and Examples

Example 1 includes a performance-enhanced computing system comprising a network controller and a processor coupled to the network controller, wherein the processor includes a plurality of instruction set architecture (ISA) instructions, which when executed by the processor, cause the processor to conduct, via a first split instruction, a first split of a first floating point (FP) number into a first part and a second part, conduct, via a second split instruction, a second split of a second FP number into a third part and a fourth part, conduct a first reduction sum operation between the first part and the third part to obtain a first intermediate result, and conduct a second reduction sum operation between the second part and the fourth part to obtain a second intermediate result.

Example 2 includes the computing system of Example 1, wherein the first split is conducted at a center of mantissa bits in the first FP number, wherein the second split is conducted at a center of mantissa bits in the second FP number, wherein the first FP number and the second FP number are to be in a single precision format, and wherein the first reduction sum operation and the second reduction sum operation are to be conducted within a normalization layer of an artificial intelligence (AI) model.

Example 3 includes the computing system of Example 1, wherein the ISA instructions, when executed, further cause the processor to conduct, via a third split instruction, a third split of the first intermediate result into a fifth part and a sixth part, conduct, via a fourth split instruction, a fourth split of the second intermediate result into a seventh part and an eighth part, conduct a third reduction sum operation between the fifth part and the seventh part to obtain a third intermediate result, and conduct a fourth reduction sum operation between the sixth part and the eighth part to obtain a fourth intermediate result.

Example 4 includes the computing system of Example 1, wherein the ISA instructions, when executed, further cause the processor to split, via a seventh split instruction, a tensor into a plurality of chunks, and wherein a first chunk in the plurality of chunks is to include the first FP number and the second FP number.

Example 5 includes the computing system of any one of Examples 1 to 4, wherein the ISA instructions, when executed, further cause the processor to conduct a first square sum reduction operation between the first part and the third part to obtain a first square output, a second square output and a third square output, conduct a second square sum reduction operation between the second part and the fourth part to obtain a fourth square output, a fifth square output and a sixth square output, conduct, via a fifth split instruction, a fifth split of the first square output, the second square output and the third square output into a first square part, a second square part, a third square part, a fourth square part, a fifth square part and a sixth square part, conduct, via a sixth split instruction, a sixth split of the fourth square output, the fifth square output and the sixth square output into a seventh square part, an eighth square part, a ninth square part, a tenth square part, an eleventh square part and a twelfth square part, conduct a fifth reduction sum operation on the first square part, the second square part, the third square part, the fourth square part, the fifth square part and the sixth square part to obtain a first intermediate square result, a second intermediate square result, a third intermediate square result, a fourth intermediate square result, a fifth intermediate square result and a sixth intermediate square result, and conduct a sixth reduction sum operation on the seventh square part, the eighth square part, the ninth square part, the tenth square part, the eleventh square part and the twelfth square part to obtain an seventh intermediate square result, an eighth intermediate square result, a ninth intermediate square result, a tenth intermediate square result, an eleventh intermediate square result and a twelfth intermediate square result.

Example 6 includes a semiconductor apparatus comprising one or more substrates, and logic coupled to the one or more substrates, wherein the logic is implemented at least partly in one or more of configurable or fixed-functionality hardware, the logic to conduct a first split of a first floating point (FP) number into a first part and a second part, conduct a second split of a second FP number into a third part and a fourth part, conduct a first reduction sum operation between the first part and the third part to obtain a first intermediate result, and conduct a second reduction sum operation between the second part and the fourth part to obtain a second intermediate result.

Example 7 includes the semiconductor apparatus of Example 6, wherein the first split is conducted at a center of mantissa bits in the first FP number, and wherein the second split is conducted at a center of mantissa bits in the second FP number.

Example 8 includes the semiconductor apparatus of Example 6, wherein the first FP number and the second FP number are to be in a single precision format.

Example 9 includes the semiconductor apparatus of Example 6, wherein the logic is further to conduct a third split of the first intermediate result into a fifth part and a sixth part, conduct a fourth split of the second intermediate result into a seventh part and an eighth part, conduct a third reduction sum operation between the fifth part and the seventh part to obtain a third intermediate result, and conduct a fourth reduction sum operation between the sixth part and the eighth part to obtain a fourth intermediate result.

Example 10 includes the semiconductor apparatus of any one of Examples 6 to 9, wherein the logic is further to split a tensor into a plurality of chunks, and wherein a first chunk in the plurality of chunks is to include the first FP number and the second FP number.

Example 11 includes the semiconductor apparatus of any one of Examples 6 to 9, wherein the first reduction sum operation and the second reduction sum operation are to be conducted within a normalization layer of an artificial intelligence (AI) model.

Example 12 includes the semiconductor apparatus of any one of Examples 6 to 11, wherein the logic is further to conduct a first square sum reduction operation between the first part and the third part to obtain a first square output, a second square output and a third square output, conduct a second square sum reduction operation between the second part and the fourth part to obtain a fourth square output, a fifth square output and a sixth square output, conduct a fifth split of the first square output, the second square output and the third square output into a first square part, a second square part, a third square part, a fourth square part, a fifth square part and a sixth square part, conduct a sixth split of the fourth square output, the fifth square output and the sixth square output into a seventh square part, an eighth square part, a ninth square part, a tenth square part, an eleventh square part and a twelfth square part, conduct a fifth reduction sum operation on the first square part, the second square part, the third square part, the fourth square part, the fifth square part and the sixth square part to obtain a first intermediate square result, a second intermediate square result, a third intermediate square result, a fourth intermediate square result, a fifth intermediate square result and a sixth intermediate square result, and conduct a sixth reduction sum operation on the seventh square part, the eighth square part, the ninth square part, the tenth square part, the eleventh square part and the twelfth square part to obtain an seventh intermediate square result, an eighth intermediate square result, a ninth intermediate square result, a tenth intermediate square result, an eleventh intermediate square result and a twelfth intermediate square result.

Example 13 includes the semiconductor apparatus of any one of Examples 6 to 11, wherein the logic coupled to the one or more substrates includes transistor regions that are positioned within the one or more substrates.

Example 14 includes at least one computer readable storage medium comprising a plurality of instruction set architecture (ISA) instructions, which when executed by a processor, cause the processor to conduct, via a first split instruction, a first split of a first floating point (FP) number into a first part and a second part, conduct, via a second split instruction, a second split of a second FP number into a third part and a fourth part, conduct a first reduction sum operation between the first part and the third part to obtain a first intermediate result, and conduct a second reduction sum operation between the second part and the fourth part to obtain a second intermediate result.

Example 15 includes the at least one computer readable storage medium of Example 14, wherein the first split is conducted at a center of mantissa bits in the first FP number, and wherein the second split is conducted at a center of mantissa bits in the second FP number.

Example 16 includes the at least one computer readable storage medium of Example 14, wherein the first FP number and the second FP number are to be in a single precision format.

Example 17 includes the at least one computer readable storage medium of Example 14, wherein the ISA instructions, when executed, further cause the processor to conduct, via a third split instruction, a third split of the first intermediate result into a fifth part and a sixth part, conduct, via a fourth split instruction, a fourth split of the second intermediate result into a seventh part and an eighth part, conduct a third reduction sum operation between the fifth part and the seventh part to obtain a third intermediate result, and conduct a fourth reduction sum operation between the sixth part and the eighth part to obtain a fourth intermediate result.

Example 18 includes the at least one computer readable storage medium of any one of Examples 14 to 17, wherein the ISA instructions, when executed, further cause the processor to split, via a seventh split instruction, a tensor into a plurality of chunks, and wherein a first chunk in the plurality of chunks is to include the first FP number and the second FP number.

Example 19 includes the at least one computer readable storage medium of any one of Examples 14 to 17, wherein the first reduction sum operation and the second reduction sum operation are to be conducted within a normalization layer of an artificial intelligence (AI) model.

Example 20 includes the at least one computer readable storage medium of any one of Examples 14 to 19, wherein the ISA instructions, when executed, further cause the processor to conduct a first square sum reduction operation between the first part and the third part to obtain a first square output, a second square output and a third square output, conduct a second square sum reduction operation between the second part and the fourth part to obtain a fourth square output, a fifth square output and a sixth square output, conduct, via a fifth split instruction, a fifth split of the first square output, the second square output and the third square output into a first square part, a second square part, a third square part, a fourth square part, a fifth square part and a sixth square part, conduct, via a sixth split instruction, a sixth split of the fourth square output, the fifth square output and the sixth square output into a seventh square part, an eighth square part, a ninth square part, a tenth square part, an eleventh square part and a twelfth square part, conduct a fifth reduction sum operation on the first square part, the second square part, the third square part, the fourth square part, the fifth square part and the sixth square part to obtain a first intermediate square result, a second intermediate square result, a third intermediate square result, a fourth intermediate square result, a fifth intermediate square result and a sixth intermediate square result, and conduct a sixth reduction sum operation on the seventh square part, the eighth square part, the ninth square part, the tenth square part, the eleventh square part and the twelfth square part to obtain an seventh intermediate square result, an eighth intermediate square result, a ninth intermediate square result, a tenth intermediate square result, an eleventh intermediate square result and a twelfth intermediate square result.

Example 21 includes a method of operating a performance-enhanced computing system, the method comprising conducting, via a first split instruction, a first split of a first floating point (FP) number into a first part and a second part, conducting, via a second split instruction, a second split of a second FP number into a third part and a fourth part, conducting a first reduction sum operation between the first part and the third part to obtain a first intermediate result, and conducting a second reduction sum operation between the second part and the fourth part to obtain a second intermediate result.

Example 22 includes an apparatus comprising means for performing the method of Example 21.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A computing system comprising:
a network controller; and
a processor coupled to the network controller, wherein the processor includes a plurality of instruction set architecture (ISA) instructions, which when executed by the processor, cause the processor to:
conduct, via a first split instruction, a first split of a first floating point (FP) number into a first part and a second part;
conduct, via a second split instruction, a second split of a second FP number into a third part and a fourth part;
conduct a first reduction sum operation between the first part and the third part to obtain a first intermediate result; and
conduct a second reduction sum operation between the second part and the fourth part to obtain a second intermediate result.

2. The computing system of claim 1, wherein the first split is conducted at a center of mantissa bits in the first FP number, wherein the second split is conducted at a center of mantissa bits in the second FP number, wherein the first FP number and the second FP number are to be in a single precision format, and wherein the first reduction sum operation and the second reduction sum operation are to be conducted within a normalization layer of an artificial intelligence (AI) model.

3. The computing system of claim 1, wherein the ISA instructions, when executed, further cause the processor to:
conduct, via a third split instruction, a third split of the first intermediate result into a fifth part and a sixth part;
conduct, via a fourth split instruction, a fourth split of the second intermediate result into a seventh part and an eighth part;
conduct a third reduction sum operation between the fifth part and the seventh part to obtain a third intermediate result; and
conduct a fourth reduction sum operation between the sixth part and the eighth part to obtain a fourth intermediate result.

4. The computing system of claim 1, wherein the ISA instructions, when executed, further cause the processor to split, via a seventh split instruction, a tensor into a plurality of chunks, and wherein a first chunk in the plurality of chunks is to include the first FP number and the second FP number.

5. The computing system of claim 1, wherein the ISA instructions, when executed, further cause the processor to:
conduct a first square sum reduction operation between the first part and the third part to obtain a first square output, a second square output and a third square output;
conduct a second square sum reduction operation between the second part and the fourth part to obtain a fourth square output, a fifth square output and a sixth square output;
conduct, via a fifth split instruction, a fifth split of the first square output, the second square output and the third square output into a first square part, a second square part, a third square part, a fourth square part, a fifth square part and a sixth square part;
conduct, via a sixth split instruction, a sixth split of the fourth square output, the fifth square output and the sixth square output into a seventh square part, an eighth square part, a ninth square part, a tenth square part, an eleventh square part and a twelfth square part;
conduct a fifth reduction sum operation on the first square part, the second square part, the third square part, the fourth square part, the fifth square part and the sixth square part to obtain a first intermediate square result, a second intermediate square result, a third intermediate square result, a fourth intermediate square result, a fifth intermediate square result and a sixth intermediate square result; and
conduct a sixth reduction sum operation on the seventh square part, the eighth square part, the ninth square part, the tenth square part, the eleventh square part and the twelfth square part to obtain an seventh intermediate square result, an eighth intermediate square result, a ninth intermediate square result, a tenth intermediate square result, an eleventh intermediate square result and a twelfth intermediate square result.

6. A semiconductor apparatus comprising:
one or more substrates; and
logic coupled to the one or more substrates, wherein the logic is implemented at least partly in one or more of configurable or fixed-functionality hardware, the logic to:
conduct a first split of a first floating point (FP) number into a first part and a second part;
conduct a second split of a second FP number into a third part and a fourth part;
conduct a first reduction sum operation between the first part and the third part to obtain a first intermediate result; and
conduct a second reduction sum operation between the second part and the fourth part to obtain a second intermediate result.

7. The semiconductor apparatus of claim 6, wherein the first split is conducted at a center of mantissa bits in the first FP number, and wherein the second split is conducted at a center of mantissa bits in the second FP number.

8. The semiconductor apparatus of claim 6, wherein the first FP number and the second FP number are to be in a single precision format.

9. The semiconductor apparatus of claim 6, wherein the logic is further to:
conduct a third split of the first intermediate result into a fifth part and a sixth part;
conduct a fourth split of the second intermediate result into a seventh part and an eighth part;
conduct a third reduction sum operation between the fifth part and the seventh part to obtain a third intermediate result; and
conduct a fourth reduction sum operation between the sixth part and the eighth part to obtain a fourth intermediate result.

10. The semiconductor apparatus of claim 6, wherein the logic is further to split a tensor into a plurality of chunks, and wherein a first chunk in the plurality of chunks is to include the first FP number and the second FP number.

11. The semiconductor apparatus of claim 6, wherein the first reduction sum operation and the second reduction sum operation are to be conducted within a normalization layer of an artificial intelligence (AI) model.

12. The semiconductor apparatus of claim 6, wherein the logic is further to:
conduct a first square sum reduction operation between the first part and the third part to obtain a first square output, a second square output and a third square output;
conduct a second square sum reduction operation between the second part and the fourth part to obtain a fourth square output, a fifth square output and a sixth square output;
conduct a fifth split of the first square output, the second square output and the third square output into a first square part, a second square part, a third square part, a fourth square part, a fifth square part and a sixth square part;
conduct a sixth split of the fourth square output, the fifth square output and the sixth square output into a seventh square part, an eighth square part, a ninth square part, a tenth square part, an eleventh square part and a twelfth square part;
conduct a fifth reduction sum operation on the first square part, the second square part, the third square part, the fourth square part, the fifth square part and the sixth square part to obtain a first intermediate square result, a second intermediate square result, a third intermediate square result, a fourth intermediate square result, a fifth intermediate square result and a sixth intermediate square result; and
conduct a sixth reduction sum operation on the seventh square part, the eighth square part, the ninth square part, the tenth square part, the eleventh square part and the twelfth square part to obtain an seventh intermediate square result, an eighth intermediate square result, a ninth intermediate square result, a tenth intermediate square result, an eleventh intermediate square result and a twelfth intermediate square result.

13. The semiconductor apparatus of claim 6, wherein the logic coupled to the one or more substrates includes transistor regions that are positioned within the one or more substrates.

14. At least one computer readable storage medium comprising a plurality of instruction set architecture (ISA) instructions, which when executed by a processor, cause the processor to:
conduct, via a first split instruction, a first split of a first floating point (FP) number into a first part and a second part;
conduct, via a second split instruction, a second split of a second FP number into a third part and a fourth part;
conduct a first reduction sum operation between the first part and the third part to obtain a first intermediate result; and
conduct a second reduction sum operation between the second part and the fourth part to obtain a second intermediate result.

15. The at least one computer readable storage medium of claim 14, wherein the first split is conducted at a center of mantissa bits in the first FP number, and wherein the second split is conducted at a center of mantissa bits in the second FP number.

16. The at least one computer readable storage medium of claim 14, wherein the first FP number and the second FP number are to be in a single precision format.

17. The at least one computer readable storage medium of claim 14, wherein the ISA instructions, when executed, further cause the processor to:
conduct, via a third split instruction, a third split of the first intermediate result into a fifth part and a sixth part;
conduct, via a fourth split instruction, a fourth split of the second intermediate result into a seventh part and an eighth part;
conduct a third reduction sum operation between the fifth part and the seventh part to obtain a third intermediate result; and
conduct a fourth reduction sum operation between the sixth part and the eighth part to obtain a fourth intermediate result.

18. The at least one computer readable storage medium of claim 14, wherein the ISA instructions, when executed, further cause the processor to split, via a seventh split instruction, a tensor into a plurality of chunks, and wherein a first chunk in the plurality of chunks is to include the first FP number and the second FP number.

19. The at least one computer readable storage medium of claim 14, wherein the first reduction sum operation and the second reduction sum operation are to be conducted within a normalization layer of an artificial intelligence (AI) model.

20. The at least one computer readable storage medium of claim 14, wherein the ISA instructions, when executed, further cause the processor to:
conduct a first square sum reduction operation between the first part and the third part to obtain a first square output, a second square output and a third square output;
conduct a second square sum reduction operation between the second part and the fourth part to obtain a fourth square output, a fifth square output and a sixth square output;
conduct, via a fifth split instruction, a fifth split of the first square output, the second square output and the third square output into a first square part, a second square part, a third square part, a fourth square part, a fifth square part and a sixth square part;
conduct, via a sixth split instruction, a sixth split of the fourth square output, the fifth square output and the sixth square output into a seventh square part, an eighth square part, a ninth square part, a tenth square part, an eleventh square part and a twelfth square part;
conduct a fifth reduction sum operation on the first square part, the second square part, the third square part, the fourth square part, the fifth square part and the sixth square part to obtain a first intermediate square result, a second intermediate square result, a third intermediate square result, a fourth intermediate square result, a fifth intermediate square result and a sixth intermediate square result; and
conduct a sixth reduction sum operation on the seventh square part, the eighth square part, the ninth square part, the tenth square part, the eleventh square part and the twelfth square part to obtain an seventh intermediate square result, an eighth intermediate square result, a ninth intermediate square result, a tenth intermediate square result, an eleventh intermediate square result and a twelfth intermediate square result.
